(19) United States
(12) Patent Application Publication
(10) Pub. No.: US 2016/0150539 A1
(43) Pub. Date: May 26, 2016

(54) INFORMATION TRANSMITTING METHOD, INFORMATION DETECTING METHOD AND APPARATUSES THEREOF AND COMMUNICATION SYSTEM

(71) Applicant: FUJITSU LIMITED, Kawasaki-shi (JP)

(72) Inventors: Yueqiao XU, Beijing (CN); Yi WANG, Beijing (CN); Hua ZHOU, Beijing (CN)

(73) Assignee: FUJITSU LIMITED, Kawasaki-shi (JP)

(21) Appl. No.: 15/014,595

(22) Filed: Feb. 3, 2016

Related U.S. Application Data
(63) Continuation of application No. PCT/CN2013/081245, filed on Aug. 9, 2013.

(51) Int. Cl. H04W 72/04

(52) U.S. Cl. CPC H04W 72/0446; H04W 72/0406; H04W 72/042

(57) ABSTRACT

An information transmitting method, information detecting method and apparatuses thereof and a communication system. The information transmitting method includes: transmitting, when control information is repeatedly transmitted over multiple subframes, a physical downlink control channel (PDCCH) or an enhanced physical downlink control channel (EPDCCH), by using one of candidate paths constituted by PDCCH or EPDCCH candidates carrying the control information over different subframes. In this embodiment, the candidate paths may be a subset of a set of all paths, hence, in performing blind detection by the user equipment, complexity of the blind detection may be lowered.

### CROSS REFERENCE TO RELATED APPLICATIONS

This application is a continuation application of International Application PCT/CN2013/081245 filed on Aug. 9, 2013, the entire contents of which are incorporated herein by reference.

### TECHNICAL FIELD

The present disclosure relates to the field of communications, and in particular to an information transmitting method, information detecting method and apparatuses thereof and a communication system.

### BACKGROUND

Machine to machine (M2M) communication, also known as machine-type communication (MTC), is seen as a form of data communication between machines that do not necessarily need human interaction. For example, a machine-type device (which is collectively referred to as an MTC UE in this application) can be a wireless user equipment (UE) configured to gather measurement information and report this information to a server at a particular time. The MTC UE can be deployed in various application scenarios, such as remote monitoring, smart metering and vehicle tracking, etc.

Currently, 3GPP has finished the study about low-cost MTC, in which low-cost techniques and the coverage performance enhancement techniques are studied and then concluded in TR36.888. The reason to study the coverage performance enhancement is that most MTC UEs (such as instruments, and meters, etc.) are supposed to be installed in the basement of residential buildings, which make MTC UEs experience very great penetration losses.

In TR36.888, all possible techniques of coverage performance enhancement for various physical channels and physical signals are given. The physical channels may include a primary synchronization signal (PSS)/a secondary synchronization signal (SSS), a physical broadcast channel (PBCH), a physical random access channel (PRACH), an (enhanced) physical downlink control channel ((E)PDCCH), a physical downlink shared channel (PDSCH)/a physical uplink shared channel (PUSCH), and a physical uplink control channel (PUCCH), etc.

During the study item (SI) discussion, the technique of repetition is a hot and straightforward way to enhance the coverage performance. And such a technique of repetition may be taken as a candidate technique of coverage performance enhancement for most physical channels and physical signals, such as PBCH, PRACH, (E)PDCCH, PDSCH/PUSCH, PUCCH. Currently, in an (E)PDCCH transmission method, one piece of DCI is only transmitted over one subframe. And for an MTC UE, the repetition in time domain means one piece of DCI can be repeatedly transmitted over multiple subframes, so as to improve transmission quality and increase downlink coverage.

In an existing standard, an (E)PDCCH carrying DCI is only transmitted over one subframe and is only transmitted once. No matter for legacy PDCCHs or enhanced PDCCHs, there are fixed search spaces for a UE to search a possible location for transmitting its DCI. The search space may include a UE-specific search space and a cell-specific search space. The UE-specific search space means control channel element (CCE) resources occupied by all possible (E)PDCCH candidates that carry DCI signaling.

For example, Table 1 gives the number of PDCCH candidates at a corresponding aggregation level (AL) and a size of a search space.

TABLE 1
PDCCH candidates monitored by a UE

| Search space | | | Number of |
|---|---|---|---|
| | Aggregation | Size (i.e. the | PDCCH |
| Type | level | number of CCEs) | candidates |
| UE-specific | 1 | 6 | 6 |
| | 2 | 12 | 6 |
| | 4 | 8 | 2 |
| | 8 | 16 | 2 |
| Cell-specific | 4 | 16 | 4 |
| (Common) | 8 | 16 | 2 |

At a certain AL, a search space is denoted as CCEs occupied by all the PDCCH candidates.

CCEs occupied by a PDCCH of a candidate number m in a search space at an aggregation level of L may be obtained through calculation by using the formulae below:

Yₖ=(A·Yₖ₋₁)mod D (1)

L{(Yₖ+m′)mod └N_{CCE,k}/L┘}+i (2);

where, Y₋₁=n_{RNTI}≠0, A=39827, D=65537, k=└nₛ/2┘, nₛ being a time slot number in a radio frame; i=0, . . . , L−1, m′=m+M^{(L)}·n_{CI}, m=0, . . . , M^{(L)}−1, M^{(L)} being the number of PDCCH candidates to be detected in a given search space, m denoting a PDCCH candidate number, n_{CI} denoting a carrier indicator, and if the UE is configured with a carrier indicator, m′=m+M^{(L)}·n_{CI}, otherwise, m′=m; n_{RNTI} denotes radio network temporary identifier; N_{CCE,k} denotes the number of CCEs available for a PDCCH of a current subframe k; and L denotes an aggregation level.

The UE determines whether the subframe has DCI signaling to be transmitted to itself by blindly detecting these defined PDCCH candidates; and by defining a search space, each UE needs only to blindly search (E)PDCCHs in the defined CCEs, and determines whether the subframe has DCI signaling to be transmitted to itself by checking a cyclic redundancy check (CRC) code.

FIG. 1 is a schematic diagram of a PDCCH search space. As shown in FIG. 1, the PDCCH search space contains a UE-specific search space and a cell-specific search space, and denotes locations where all the PDCCHs possibly appear.

Table 1 defines the number of PDCCH candidates monitored at each aggregation level, and each UE may calculate the CCEs occupied by each PDCCH candidate at each aggregation level by using formulae (1)-(2). For example, in a case where AL=2, the UE calculates, by using the formulae, that the CCEs occupied by PDCCH candidate 1 are CCE0-CCE1, and the CCEs occupied by PDCCH candidate 2 are CCE2-CCE3, and so on. In this way, the CCEs occupied by all the PDCCH candidates at all the aggregation levels are calculated, and blind detection is performed for each case.

FIG. 2 is schematic diagrams of the CCEs occupied by each PDCCH candidate at each aggregation level, i.e. schematic diagrams of search spaces at various aggregation levels.

It should be noted that the above description of the background is merely provided for clear and complete explanation of the present disclosure and for easy understanding by those skilled in the art. And it should not be understood that the above technical solution is known to those skilled in the art as it is described in the background of the present disclosure.

### SUMMARY

However, for a UE under poor coverage performance, such as an MTC UE, in order to improve coverage performance of downlink control channels, (E)PDCCHs carrying identical DCI will perform repeated transmission over multiple subframes. Under such circumstances, if detection is still performed according to an existing method, on one hand, as the UE does not know a candidate number of an (E)PDCCH carrying the DCI copy in each subframe, and on the other hand, the UE does not know the relationship between candidate numbers of (E)PDCCHs carrying the DCI copy on different subframes, and after the UE, such as an MTC UE, determines a starting subframe of (E)PDCCH repetition and repeatedly transmits spanned subframes, such as TTI#n-TTI#n+N, the UE needs to attempt all combinations of (E)PDCCH candidate numbers between the N subframes, so as to find correct candidate number paths of the (E)PDCCHs repeatedly transmitting the DCI along different subframes, thereby making complexity of the blind detection increased greatly.

Embodiments of the present disclosure provide an information transmitting method, information detecting method and apparatuses thereof and a communication system, which may greatly reduce the number of times of blind detection by a UE.

According to a first aspect of the embodiments of the present disclosure, there is provided an information transmitting method, including:

transmitting, when control information is repeatedly transmitted over multiple subframes, a physical downlink control channel (PDCCH) or an enhanced physical downlink control channel (EPDCCH), by using one of candidate paths constituted by PDCCH or EPDCCH candidates carrying the control information over different subframes.

According to a second aspect of the embodiments of the present disclosure, there is provided an information detecting method, including:

determining candidate paths for a physical downlink control channels (PDCCHs) or an enhanced physical downlink control channels (EPDCCHs) carrying control information; wherein the candidate paths are constituted by PDCCH or EPDCCH candidates carrying the control information over different subframes; and

performing detection according to paths to which the candidate paths correspond.

According to a third aspect of the embodiments of the present disclosure, there is provided an information transmitting apparatus, including:

an information transmitting unit configured to repeatedly transmit control information over multiple subframes; wherein a physical downlink control channel (PDCCH) or an enhanced physical downlink control channel (EPDCCH) is transmitted by using one of candidate paths constituted by PDCCH or EPDCCH candidates carrying the control information over different subframes.

According to a fourth aspect of the embodiments of the present disclosure, there is provided an information detecting apparatus, including:

a search space determining unit configured to determine candidate paths for a physical downlink control channel (PDCCH) or an enhanced physical downlink control channel (EPDCCH) carrying control information; wherein the candidate paths are constituted by PDCCH or EPDCCH candidates carrying the control information over different subframes; and a detecting unit configured to perform detection according to paths to which the candidate paths correspond.

According to a fifth aspect of the embodiments of the present disclosure, there is provided a base station, including the apparatus according to the third aspect of the embodiments of the present disclosure.

According to a six aspect of the embodiments of the present disclosure, there is provided a UE, including the apparatus according to the fourth aspect of the embodiments of the present disclosure.

According to a seventh aspect of the embodiments of the present disclosure, there is provided a communication system, including the base station according to in the fifth aspect and the UE according to the sixth aspect of the embodiments of the present disclosure.

According to an eighth aspect of the embodiments of the present disclosure, there is provided an information configuring method, including:

configuring a mapping relationship between an aggregation level and the number of candidate paths; wherein the candidate paths are constituted by PDCCH or EPDCCH candidates carrying control information over different subframes.

According to a ninth aspect of the embodiments of the present disclosure, there is provided an information configuring apparatus, including:

an information configuring unit configured to configure a mapping relationship between an aggregation level and the number of candidate paths; wherein the candidate paths are constituted by PDCCH or EPDCCH candidates carrying control information over different subframes.

According to a tenth aspect of the embodiments of the present disclosure, there is provided a base station, including the apparatus according to the ninth aspect of the embodiments of the present disclosure.

According to an eleventh aspect of the embodiments of the present disclosure, there is provided a communication system, including the base station according to the tenth aspect of the embodiments of the present disclosure.

According to a twelfth aspect of the embodiments of the present disclosure, there is provided a computer-readable program, wherein when the program is executed in an information transmitting apparatus or a base station, the program enables a computer to carry out the information transmitting method according to the first aspect of the embodiments of the present disclosure in the information transmitting apparatus or the base station.

According to a thirteenth aspect of the embodiments of the present disclosure, there is provided a storage medium in which a computer-readable program is stored, wherein the computer-readable program enables a computer to carry out the information transmitting method according to the first aspect of the embodiments of the present disclosure in an information transmitting apparatus or a base station.

According to a fourteenth aspect of the embodiments of the present disclosure, there is provided a computer-readable program, wherein when the program is executed in an information detecting apparatus or a user equipment, the program enables a computer to carry out the information detecting method according to the second aspect of the embodiments of the present disclosure in the information detecting apparatus or the user equipment.

According to a fifteenth aspect of the embodiments of the present disclosure, there is provided a storage medium in which a computer-readable program is stored, wherein the computer-readable program enables a computer to carry out the information detecting method according to the second aspect of the embodiments of the present disclosure in an information detecting apparatus or a user equipment.

According to a sixteenth aspect of the embodiments of the present disclosure, there is provided a computer-readable program, wherein when the program is executed in an information configuring apparatus or a base station, the program enables a computer to carry out the information configuring method according to the eighth aspect of the embodiments of the present disclosure in the information configuring apparatus or the base station.

According to a seventeenth aspect of the embodiments of the present disclosure, there is provided a storage medium in which a computer-readable program is stored, wherein the computer-readable program enables a computer to carry out the information configuring method according to the eighth aspect of the embodiments of the present disclosure in an information configuring apparatus or a base station.

An advantage of the embodiments of the present disclosure exists in that transmitting control information by using one of the predetermined candidate paths, and detecting the control information from a predefined number of candidate paths, the number of times of blind detection may be reduced.

With reference to the following description and drawings, the particular embodiments of the present disclosure are disclosed in detail, and the principles of the present disclosure and the manners of use are indicated. It should be understood that the scope of the embodiments of the present disclosure is not limited thereto. The embodiments of the present disclosure contain many alternations, modifications and equivalents within the scopes of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of the present disclosure, which constitute a part of the specification and illustrate the preferred embodiments of the present disclosure, and are used for setting forth the principles of the present disclosure together with the description. It is obvious that the accompanying drawings in the following description are some embodiments of the present disclosure only, and a person of ordinary skill in the art may obtain other accompanying drawings according to these accompanying drawings without making an inventive effort. In the drawings:

FIG. 1 is a schematic diagram of a PDCCH search space of an existing mechanism;

FIG. 2 shows search spaces at various aggregation levels;

FIG. 3 is a schematic diagram of candidate paths for an (E)PDCCH transmitting DCI repeatedly;

FIG. 4 is a schematic diagram of candidate paths for an (E)PDCCH transmitting DCI repeatedly;

FIG. 5 is a schematic diagram of a relationship between (E)PDCCH candidates according to Embodiment 1 of the present disclosure;

FIG. 6 is a schematic diagram of a relationship between (E)PDCCH candidates according to Embodiment 1 of the present disclosure;

FIG. 7 is a flowchart of the information transmitting method according to Embodiment 2 of the present disclosure;

FIG. 8 is a flowchart of the information detecting method according to Embodiment 3 of the present disclosure;

FIG. 9 is a schematic diagram of a structure of the information transmitting apparatus according to Embodiment 4 of the present disclosure;

FIG. 10 is a schematic diagram of a structure of the information detecting apparatus according to Embodiment 5 of the present disclosure;

FIG. 11 is a schematic diagram of a structure of the base station according to Embodiment 6 of the present disclosure;

FIG. 12 is a schematic diagram of a structure of the UE according to Embodiment 7 of the present disclosure; and

FIG. 13 is a schematic diagram of a structure of the communication system according to Embodiment 8 of the present disclosure.

### DETAILED DESCRIPTION

Various embodiments of the present disclosure shall be described below with reference to the accompanying drawings. The embodiments are illustrative only, and not intended to limit the present disclosure.

A problem of high complexity of detection in an existing detection method shall be described first below, two cases of repeatedly transmitting (E)PDCCHs over multiple subframes in a time domain being taken as examples.

The first case: one piece of DCI is repeatedly transmitted once over a subframe and N subframes are used, and the DCI is transmitted N times in a time domain.

For such a case of repeated transmission of (E)PDCCHs in the time domain, as a terminal equipment does not know candidate numbers of (E)PDCCHs transmitting the DCI over each subframe, it is assumed that an aggregation level is L, there will be (M^{(L)})^{N} possibilities for combinations of candidate numbers of the (E)PDCCHs repeatedly transmitting N times over N subframes.

Hence, in such a case, there are totally (M^{(L)})^{N} candidate paths repeatedly transmitting the DCI copy at a network side, such as a base station; and a UE, such as an MTC UE, needs to exhaustively search (M^{(L)})^{N} times to find out paths of correct (E)PDCCHs repeatedly transmitting N times over N subframes at the aggregation level L. It can be seen that complexity of such blind detection will be increased in an exponential distribution manner, and will be very high.

For example, at a given aggregation level L over N subframes, cascading is performed according to the numbers of PDCCH candidate defined in Table 1, and j=1˜N×M^{(L)} is used for re-numbering, denoting an available number of PDCCH candidates. Following description is given with reference to Table 1.

FIG. 3 is a schematic diagram of candidate paths for an (E)PDCCH transmitting DCI repeatedly. As show in FIG. 3, when AL=4, it can be seen from Table 1 that the number of PDCCH candidates is 2, and the number of available PDCCH candidates along N subframes (TTI#i-TTI#i+N−1) is 2N; the 2N available PDCCH candidates along the N subframes are cascaded and numbered sequentially, which are j=#1˜#2N (referring to logic numbers) in turn. Hence, different combinations of the 2N PDCCH candidates may constitute a set of candidate paths. As the above paths are indicated by the PDCCH candidate numbers, the candidate paths may be referred to as candidate number paths. A PDCCH path carrying a DCI copy is illustrated in FIG. 3.

In such a case, there are totally (M⁽⁴⁾)^{N}=2^{N} PDCCH candidate number paths for repeatedly transmitting the DCI copy at the network side, such as a base station (eNB). The MTC UE needs at most to exhaustively search (M⁽⁴⁾)^{N}=2^{N} times to find out paths of correct PDCCHs repeatedly transmitting N times over N subframes at AL=4, and a search space for each (E)PDCCH candidate over each subframe, i.e. the occupied CCEs, may be determined according to an existing standard, with the complexity of the blind detection being very high.

The second case: DCI is repeatedly transmitted multiple times over a subframe, and N subframes may be used.

In such a case, it is assumed that an aggregation level is L, and K times of repeated transmission of (E)PDCCHs is completed over N subframes. As a terminal equipment does not know the number of times of transmission of DCI copy over each subframe and candidate numbers of the (E)PDCCHs transmitting the DCI copy over each subframe, the number of all (E)PDCCH candidates is N×M^{(L)} at a given aggregation level L over N subframes.

FIG. 4 is a schematic diagram of candidate paths for an (E)PDCCH transmitting DCI repeatedly.

As shown in FIG. 4, when an aggregation level L is given over N subframes, the number of all (E)PDCCH candidates is N×M^{(L)}, with a cascading number being denoted as #1˜#N×M^{(L)}. Hence, it corresponds to that K (E)PDCCH candidates carrying the DCI copy need to be found in such a set, which is a permutation and combination problem. There may be C_{(M}_{^{(L)}}_{)N}^{K} possibilities for (E)PDCCH repetition paths. Hence, the MTC UE needs to exhaustively search C_{(M}_{^{(L)}}_{)N}^{K} times to find out paths of correct (E)PDCCHs repeatedly transmitting K times over N subframes at the aggregation level L. And over each subframe, a search space of each (E)PDCCH candidate, i.e. the occupied CCEs, may be determined according to an existing standard, with the complexity of the blind detection being also very high.

On the basis of the two cases enumerated above, although the method for repeatedly transmitting (E)PDCCHs in the time domain can improve quality for receiving the downlink control signaling by the MTC UE, the complexity of the blind detection will be correspondingly increased. Hence, there is a need to design an effective method of repeatedly transmitting (E)PDCCHs, which may ensure appropriate complexity of blind detection by a terminal while improving the coverage.

Embodiments of the present disclosure provide an information transmitting method, information detecting method and apparatuses thereof and a communication system; in repeatedly transmitting (E)PDCCHs over multiple subframes, the (E)PDCCHs may be transmitted and detected by using subset(s) of the above set of candidate paths, thereby reducing complexity of blind detection.

At a network side (such as a base station), a set of (E)PDCCH candidate paths carrying control signaling (such as DCI signaling) may be determined first, as described above, each candidate path may be a combination of (E)PDCCH candidate numbers, that is, a relationship between the candidate numbers. Hence, in repeatedly transmitting the (E)PDCCHs, the base station may select one candidate path therefrom, and select corresponding (E)PDCCH candidates at different TTIs according to a relationship between (E)PDCCH candidate numbers of the candidate path, so as to transmit the carried control information. The relationship between the candidate numbers of the (E)PDCCHs carrying the control signaling (such as DCI signaling) may be a determined relationship. Thus, in repeatedly transmitting the (E)PDCCHs, the network side may transmit the (E)PDCCHs carrying the control information according to the determined relationship. The control signaling may be DCI.

At a UE side, a new UE-specific search space is defined. The UE-specific search space is the above-described candidate paths, that is, candidate paths combined by (E)PDCCH candidates carrying control information over different subframes, and the candidate paths may be a subset of a set constituted by all candidate paths.

Furthermore, the number of candidate paths needing to be monitored by each UE may be predetermined. In each path, a relationship between (E)PDCCH candidate numbers may be a determined relationship, such as a relationship of which the UE is notified by the network, or a relationship agreed on between both parties, or (E)PDCCH candidate numbers in the path at different TTIs are calculated according to a predefined relation (such as a function), and then CCE resources occupied by each candidate number of (E)PDCCHs are calculated according to an existing standard. Hence, the UE may perform detection according to the UE-specific search space, thereby reducing the number of times of blind detection.

The embodiments of the present disclosure shall be described below with reference to the accompanying drawings.

### Embodiment 1

Embodiment 1 of the present disclosure provides an information transmitting method, including:

when control information is repeatedly transmitted over multiple subframes, transmits a physical downlink control channel (PDCCH) or an enhanced physical downlink control channel (EPDCCH) by using one of candidate paths constituted by PDCCH or EPDCCH candidates carrying the control information over different subframes.

In this embodiment, a base station may select a candidate path, and select corresponding (E)PDCCH candidates over different subframes (TTIs) according to a relationship between (E)PDCCH candidate numbers of the candidate path, so as to transmit the carried control information.

The number of the candidate paths may be less than or equal to the number of all paths combined by the PDCCH or (E)PDCCH candidates. The candidate paths combined by the PDCCH or (E)PDCCH candidates carrying the control information over different subframes are similar to those as shown in FIGS. 3 and 4, and in order to further reduce complexity of blind detection by the UE, the number of the candidate paths may be made less than the number of all the combined paths, that is, the candidate paths may be a subset of a set constituted by all the candidate paths.

In this embodiment, in the set of candidate paths of the (E)PDCCHs carrying the control information (such as DCI signaling), each candidate path is a combination of (E)PDCCH candidate numbers (each candidate number corresponding to a subframe), i.e. a relationship between the candidate numbers. Hence, determination of the candidate paths is the determination of a relationship between the candidate numbers.

Thus, in repeatedly transmitting the (E)PDCCHs, a network side, such as a base station, selects a candidate path in the set of candidate paths, and selects corresponding (E)PDCCH candidates over different subframes (TTIs) according to a relationship between (E)PDCCH candidate numbers of the candidate path, so as to transmit the carried control information. That is, the relationship between the candidate numbers of the (E)PDCCHs carrying the control information (such as DCI signaling), i.e. the candidate paths, may be a determined relationship. Hence, in repeatedly transmitting the (E)PDCCHs, the network side may transmit the (E)PDCCHs carrying the control information according to the determined relationship. The control signaling may be DCI. For example, the transmission may be performed according to the paths shown by arrows in FIG. 3.

It can be seen from the above embodiment that transmitting the (E)PDCCHs by using the determined candidate paths, the number of times of blind detection by the UE may be reduced. In this embodiment, the candidate paths, i.e. the relationship between the candidate numbers, may be configured by using high layer signaling (such as RRC signaling) and the UE is notified of the relationship, or may be calculated according to a predefined relation (such as a predefined formula), the relation being known to the base station and the UE, or may be determined according to a relationship known to the base station and the UE.

In this embodiment, the relationship between the candidate numbers of the (E)PDCCHs carrying the control information may constitute a set of candidate paths, and the (E)PDCCHs are transmitted according to the relationship, i.e. the candidate paths. The network side may indicate the relationship between the (E)PDCCH candidate numbers by using a bitmap, i.e. indicating the paths transmitting the (E)PDCCHs; or the paths may be calculated by using a predefined relation; or the base station side and the UE side may agree on the used paths.

For example, as to the above first case where the (E)PDCCHs are repeatedly transmitted over multiple subframes, the candidate paths may be denoted as that control information transmitted over different subframes is carried by logic (E)PDCCH candidates having identical or different numbers.

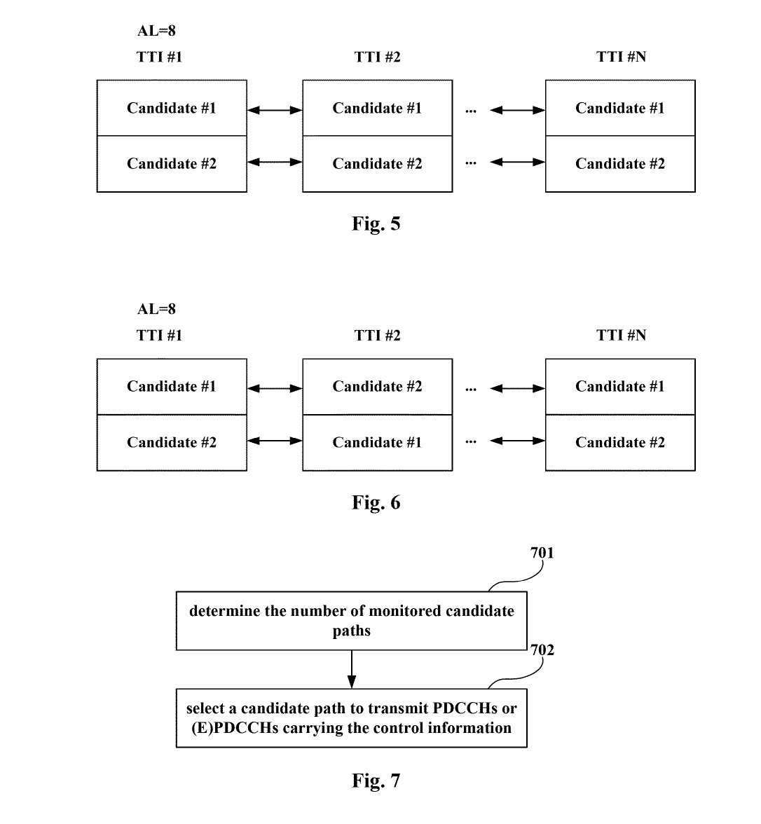

FIGS. 5 and 6 give description taking that DCI is transmitted at an aggregation level AL=8 and the number of the (E)PDCCH candidates is 2 as an example.

As shown in FIG. 5, the relationship between the (E)PDCCH candidates is: over subframes 1-N, i.e. at transmission time intervals (TTIs) 1-N, the transmitted DCI is carried by logic (E)PDCCH candidates having identical numbers (such as #1 and #2), i.e. the numbers of the (E)PDCCH candidates in the first path are all #1, and the numbers of the (E)PDCCH candidates in the second path are all #2. That is, the candidate number of the PDCCHs carrying actual DCI transmission over the first subframe is #1, and the candidate numbers of the PDCCHs transmitting the DCI over subsequent N-1 subframes are also #1; and the candidate number of the PDCCHs carrying actual DCI transmission over the first subframe is #2, and the candidate numbers of the PDCCHs transmitting the DCI over subsequent N-1 subframes are also #2. With this method, the candidate numbers of the logic PDCCHs carrying actual DCI transmission over N subframes are identical. Thus, in such a case, it is assumed that at a certain aggregation level, the number of the repetition candidate paths of the (E)PDCCHs is identical to the number of the PDCCH candidates defined under a starting subframe.

Furthermore, as shown in FIG. 6, the transmitted control information may be carried by logic (E)PDCCH candidates having different numbers.

It can be seen from the above that in the case where the aggregation level AL=8 and the number of the (E)PDCCH candidates is 2, when the (E)PDCCHs are repeatedly transmitted over N subframes, the number of all the paths is (M^{(L)})^{N}, that is, (M⁽⁸⁾)^{N}=2^{N}; where, N is greater than 1; and the determined number of the candidate paths is 2, that is, the candidate paths are subsets of all the paths.

It can be seen from the above embodiment that when the UE blindly detects N pieces of DCI, the blind detection may be performed at most M^{(L)} times at a certain aggregation level AL, while the detection needs to be performed (M^{(L)})^{N} times in an existing mechanism. It can be seen that the embodiment of the present disclosure may greatly reduce the number of times of blind detection.

As to the above second case, similar to the first case, the relationship between the candidate numbers of the PDCCHs carrying the control information, i.e. the candidate paths, is predetermined, and when the UE blindly detects N pieces of DCI, the blind detection is performed at most f_{(N)}^{(L)} times at a certain aggregation level AL, while C_{M}_{^{(L)}}_{N}^{K} times of detection needs to be performed according to an existing mechanism, f_{(N)}^{(L)} being less than C_{M}_{^{(L)}}_{N}^{K}. It can be seen that the number of times of the blind detection may be greatly reduced by means of the embodiment of the present disclosure.

### Embodiment 2

FIG. 7 is a flowchart of the information transmitting method according to Embodiment 2 of the present disclosure, which is based on Embodiment 1. What is different from Embodiment 1 is that the number of the candidate paths may be predetermined, for example, the number of the candidate paths that can be possibly monitored at most at each aggregation level may be determined according to a pre-known relationship table.

As shown in FIG. 7, the method includes:

step 701: determines the number of monitored candidate paths;

in this embodiment, the candidate paths are combined by PDCCH or (E)PDCCH candidates carrying control information;

in order to reduce the number of times of blind detection, the number of the candidate paths may be predetermined. For example, the number may be configured by a network side, such as a base station, or the number may be determined according to a predefined relationship; and the number may be less than the number of all possible paths;

for example, the number of candidate paths at each aggregation level may be predetermined, as shown in tables 2 and 3, and the number is determined by looking up the tables, which shall be described below;

step 702: selects a candidate path from the candidate paths with a predetermined number to transmit PDCCHs or (E)PDCCHs carrying the control information;

A process of transmission is similar to that in Embodiment 1, which shall not be described herein any further.

In this embodiment, corresponding to the first case, for example, in step 701, Table 2 is defined, giving the number of the candidate paths of (E)PDCCHs needing to be monitored by the UE at a predetermined coverage target (or at N repeated TTIs). Table 2 may be used to determine that the number of times of repetition at different aggregation levels is M1, and when the (E)PDCCHs are repeatedly transmitted, a network side (such as a base station) selects one of the candidate paths defined in Table 2 to repeatedly transmit the (E)PDCCHs. Furthermore, the number of the (E)PDCCH candidate paths needing to be monitored by the UE is also determined in Table 2. As shown in Table 2, when the aggregation level is 1, the number of the candidate paths is A⁽¹⁾, when the aggregation level is 2, the number of the candidate paths is A⁽²⁾, when the aggregation level is 4, the number of the candidate paths is A⁽⁴⁾, and when the aggregation level is 8, the number of the candidate paths is A⁽⁸⁾.

TABLE 2
The number of the candidate paths needing to be monitored
by the UE when the (E)PDCCHs are repeatedly
transmitted in a time domain

| | Enhanced coverage performance |
|---|---|
| | (or the number N of times |
| | of repetition) |
| Aggregation level | M1 times of repetition/M1 TTIs |
| Aggregation level AL = 1 | A⁽¹⁾ |
| Aggregation level AL = 2 | A⁽²⁾ |
| Aggregation level AL = 4 | A⁽⁴⁾ |
| Aggregation level AL = 8 | A⁽⁸⁾ |

In Table 2, a size of a value of A^{(L)} (L=1, 2, 4, 8) may be less than a size (M^{(L)})^{N} of a complete set, and the size of the value may be equal to the number M^{(L)} of the PDCCH candidates at each TTI at a corresponding aggregation level. The relationship between the (E)PDCCH candidate numbers of each candidate path may be a determined relationship, or may be calculated by using a predefined relation (function).

In this embodiment, corresponding to the second case, for example, in step 701, Table 3 is defined, which is used to determine that the number of times of repetition over N TTIs at different aggregation levels is M2, and when the (E)PDCCHs are repeatedly transmitted, a network side (such as a base station) selects one of the candidate paths defined in Table 3 to repeatedly transmit the (E)PDCCHs. Furthermore, the number of the (E)PDCCH candidate paths needing to be monitored by the UE is also determined in Table 3. As shown in Table 3, when the aggregation level is 1, the number of the candidate paths is B⁽¹⁾, when the aggregation level is 2, the number of the candidate paths is B⁽²⁾, when the aggregation level is 4, the number of the candidate paths is B⁽⁴⁾, and when the aggregation level is 8, the number of the candidate paths is B⁽⁸⁾.

TABLE 3
The number of the candidate paths needing to
be monitored by the UE when the
(E)PDCCHs are repeatedly transmitted

| | Enhanced coverage performance |
|---|---|
| | (or the number N of |
| | times of repetition) |
| Aggregation level | M2 times of repetition/N TTIs |
| Aggregation level AL = 1 | B ⁽¹⁾ |
| Aggregation level AL = 2 | B ⁽²⁾ |
| Aggregation level AL = 4 | B ⁽⁴⁾ |
| Aggregation level AL = 8 | B ⁽⁸⁾ |

Likewise, in Table 3, a size of a value of B″ (L=1, 2, 4, 8) may be less than a size C_{M}_{^{(L)}}_{N}^{K} of a complete set.

The relationship between the (E)PDCCH candidate numbers of each candidate path may be a determined relationship, or may be calculated by using a predefined relation (function).

In tables 2 and 3, the numbers of times of repetition may be any integers, such as 10, 20, etc., and values of A^{(L)} (L=1, 2, 4, 8) and B^{(L)} (L=1, 2, 4, 8) may be determined according to an actual situation.

### Embodiment 3

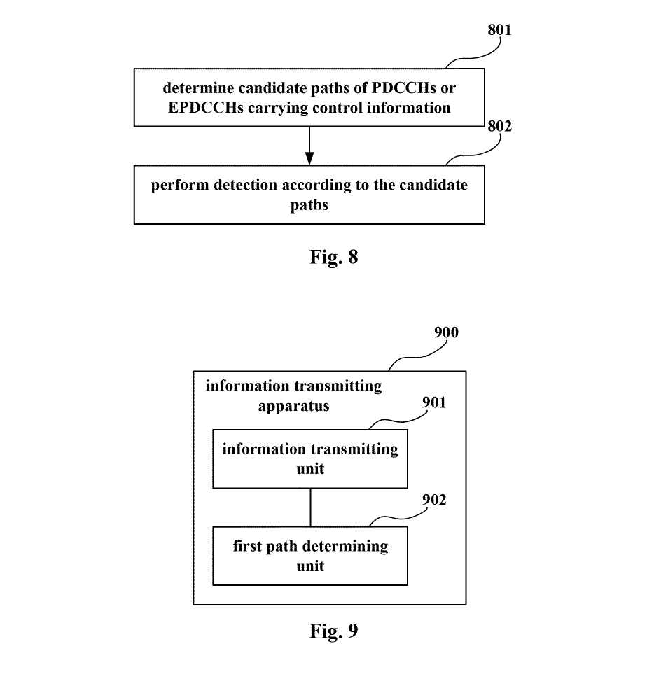

FIG. 8 is a flowchart of the information detecting method according to Embodiment 3 of the present disclosure. As shown in FIG. 8, the method includes:

step 801: determines candidate paths of PDCCHs or EPDCCHs carrying control information; the candidate paths are constituted by PDCCH or EPDCCH candidates carrying the control information over different subframes;

in this embodiment, the candidate paths may also be referred to as a UE-specific search space; a UE detects each candidate path in the UE-specific search space;

in this embodiment, determination of the candidate paths is to determine a relationship between the (E)PDCCH candidate numbers; for example, the UE may receive the relationship between the candidate numbers of the (E)PDCCHs carrying the control information in each candidate path configured by a network side, so as to determine the UE-specific search space according to the relationship; furthermore, the UE may also obtain the relationship through calculation according to a predefined equation, or the relationship may be predetermined by the base station and the UE;

step 802: performs detection according to the candidate paths, i.e. performs detection according to the determined UE-specific search space;

in this embodiment, after the candidate paths are determined, CCEs occupied by the (E)PDCCH candidates over different subframes to which each candidate path corresponds may be calculated by using an existing standard, such as formulae (1) and (2) described in the Background, which shall not be described herein any further.

In this embodiment, the candidate paths for the (E)PDCCHs carrying the control information are subsets of a set constituted by all possible candidates. For example, when the (E)PDCCHs are transmitted over N subframes and transmitted once over each subframe, the number of all the candidate paths is (M^{(L)})^{N}, and when the (E)PDCCHs are transmitted over N subframes and transmitted K time over each subframe, the number of all cascades is C_{M}_{^{(L)}}_{N}^{K}. Hence, the number of the path candidates of the search space is a subset of the set; where, both N and K are positive integers.

In this embodiment, a size of the subset may be learnt by defining a new Table 2 or Table 3, that is, the number of the candidate paths constituted by (E)PDCCH candidates at different aggregation levels at different times of repetition may be determined by defining the new Table 2 or Table 3.

Hence, in this embodiment, the method may further include: determines the number of the candidate paths constituted by (E)PDCCH candidates at different aggregation levels at different times of repetition according to a predefined table of relationship, such as Table 2 or Table 3. Hence, in step 801, the UE performs detection in the candidate paths of a determined number.

It can be seen from the above embodiment that the network side (such as a base station) selects one of the candidate paths, and selects corresponding (E)PDCCHs at different TTIs according to the relationship between the (E)PDCCH(E) candidate numbers in the candidate path to carry the transmission of the control information. The relationship between the candidate numbers of the (E)PDCCHs carrying the control information (such as DCI signaling) may be a determined relationship. Hence, when the (E)PDCCHs are repeatedly transmitted, the network side may transmit the (E)PDCCHs carrying the control information according to the relationship. The control signaling may be DCI.

At the UE side, a new UE-specific search space is defined, which refers to the combined candidate paths carrying the (E)PDCCH candidates over different subframes, the candidate paths being subsets of a set of all the paths. As described above, the number of the candidate paths needing to be monitored by each UE is defined. The relationship between the (E)PDCCH candidate numbers in each path may be a determined relationship, such as a relationship of which the UE is notified by the network side, or a relationship agreed on between both parties, or (E)PDCCH candidate numbers in the path at different TTIs are calculated according to a function expression, and then CCE resources occupied by each candidate number of (E)PDCCHs are calculated according to an existing standard. Hence, the UE may perform detection according to the UE-specific search space, thereby reducing the number of times of blind detection.

It can be seen from the above embodiment that when the UE blindly detects N pieces of DCI, the blind detection may be performed at most M^{(L)} times at a certain aggregation level AL, while the detection needs to be performed (M^{(L)})^{N} times in an existing mechanism. It can be seen that the embodiment of the present disclosure may greatly reduce the number of times of blind detection.

As to the above second case, similar to the first case, the relationship between the candidate numbers of the PDCCHs carrying the control information, i.e. the candidate paths, is predetermined, and when the UE blindly detects N pieces of DCI, the blind detection is performed at most f_{(N)}^{(L)} times at a certain aggregation level AL, f_{(N)}^{(L)} being less than C_{M}_{^{(L)}}_{N}^{K}, while C_{M}_{^{(L)}}_{N}^{K} times of detection needs to be performed according to an existing mechanism. It can be seen that the number of times of the blind detection may be greatly reduced with the embodiment of the present disclosure.

A process of detection shall be described below taking that the (E)PDCCH candidate numbers at different TTIs in each candidate path are calculated by using a formula as an example.

In blindly detecting (E)PDCCH repetition, the UE needs first to determine a starting subframe and the number N of repeatedly used TTIs at each time of (E)PDCCH repetition, and then determine (E)PDCCH candidate numbers over N subframes in each candidate path.

For example, when the UE determines a starting subframe #k and the subsequent subframes #k+1˜#k+N−1 of a certain (E)PDCCH repetition, which is totally N TTIs (i=0, 1, 2, . . . , N−1), for the (E)PDCCH repetition, the used (E)PDCCH candidate numbers at different TTIs in each candidate path may be obtained through calculation by using a formula;

the formula is related to a radio network temporary identifier (RNTI) of the UE, the starting subframe #k of the current (E)PDCCH repetition, an i-th TTI (i=0, 1, 2, . . . , N−1) of the current (E)PDCCH repetition and a candidate path number #a (a=1, 2, . . . , A^{(L)}).

An expression for calculating (E)PDCCH candidate numbers at N TTIs in a candidate path numbered #a at an aggregation level AL=L is given below:

m=i×M^{(L)}+(Eₖ₊ᵢ+a)mod M^{(L)} (3);

where, m=0, 1, . . . M^{(L)}, M^{(L)}+1, . . . , M^{(L)}N denotes logic numbers formed by cascading all the PDCCH candidates at N TTIs at an aggregation level AL=L, and a=0, 1, . . . , A^{(L)} denotes the candidate path numbers at the aggregation level AL=L monitored by the UE;

Eₖ=(A·Eₖ₋₁) mod D, which is similar to Formula (1), E₋₁=n_{RNTI}, A=39827, D=65537, and k denoting a starting subframe number of the (E)PDCCH repetition.

With the above formula, the (E)PDCCH candidate numbers at the i-th TTI in the candidate path numbered #a at the aggregation level AL=L at this time of (E)PDCCH repetition are calculated.

Above Expression (3) is an embodiment of the present disclosure only, and the present disclosure is not limited thereto.

### Embodiment 4

FIG. 9 is a schematic diagram of a structure of the information transmitting apparatus according to Embodiment 4 of the present disclosure. As shown in FIG. 9, the apparatus 900 includes: an information transmitting unit 901 configured to repeatedly transmit control information over multiple subframes; wherein a PDCCH or an EPDCCH is transmitted by using one of multiple candidate paths constituted by PDCCH or EPDCCH candidates carrying the control information over different subframes.

In this embodiment, the number of the candidate paths may be less than or equal to the number of all paths combined by the PDCCH or (E)PDCCH candidates, and the transmission of the (E)PDCCHs is similar to that according to embodiments 1 and 2, which shall not be described herein any further.

In this embodiment, the candidate paths may be expressed by a relationship between the candidate numbers of the (E)PDCCHs carrying the control information.

It can be seen from the above embodiment that the (E)PDCCHs are transmitted by using the determined candidate paths. Hence, when the UE blindly detects the DCI, the number of times of blind detection may be greatly reduced.

As shown in FIG. 9, the apparatus 900 may further include a first path determining unit 902 configured to configure the candidate paths by using high layer signaling, or calculate the candidate paths according to a predefined relation, or determine the candidate paths according to prestored path information.

In this embodiment, the apparatus 900 may further include an information notifying unit (not shown) configured to notify the UE of the above configured candidate paths.

Furthermore, a storing unit (not shown) may be included, which is configured to store the above candidate paths.

In this embodiment, the apparatus 900 may further include a first path number determining unit (not shown) configured to preconfigure the number of the candidate paths, or determine the number of the candidate paths according to prestored path number information.

Similar to Embodiment 2, the determination is performed according to Table 2 or Table 3, which shall not be described herein any further.

In this embodiment, the apparatus 900 may be a network side equipment, which may be a base station.

### Embodiment 5

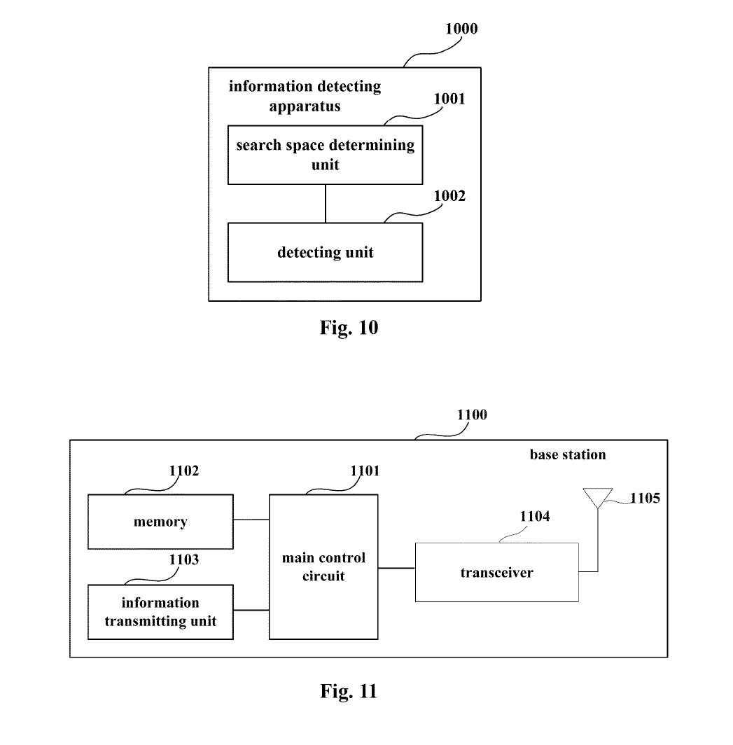

FIG. 10 is a schematic diagram of a structure of the information detecting apparatus according to Embodiment 5 of the present disclosure. As shown in FIG. 10, the apparatus 1000 includes: a search space determining unit 1001 configured to determine candidate paths for PDCCHs or EPDCCHs carrying control information; wherein the candidate paths are constituted by PDCCH or EPDCCH candidates carrying the control information over different subframes; and a detecting unit 1002 configured to perform detection according to paths to which the candidate paths correspond.

Particular methods for determining a search space and for detecting according to Embodiment 3 shall not be described herein any further.

In this embodiment, the apparatus 1000 may further include a receiving unit (not shown) configured to receive the above configured candidate paths configured by a network side; or the apparatus 1000 may further include a calculating unit (not shown) configured to calculate the above candidate paths according to a predefined relation.

Furthermore, the apparatus 1000 may further include a storing unit (not shown) configured to store the above candidate paths, or to store a relation used for calculating the above candidate paths.

In this embodiment, a process of detection of the apparatus 1000 according to Embodiment 2 shall not be described herein any further.

In this embodiment, the apparatus 1000 further includes a second path determining unit (not shown) configured to receive the number of the candidate paths preconfigured by a network side, or determine the number of the candidate paths according to prestored path number information.

In this embodiment, the apparatus 1000 may be a UE.

It can be seen from the above embodiment that with the embodiment of the present disclosure, when the UE blindly detects N pieces of DCI, the number of times of blind detection may be greatly reduced.

### Embodiment 6

Embodiment 6 of the present disclosure provides a base station, including the information transmitting apparatus according to Embodiment 3, with its particular structure being according to Embodiment 4, which shall not be described herein any further.

FIG. 11 is a schematic diagram of a structure of the base station according to Embodiment 6 of the present disclosure. As shown in FIG. 6, the base station 1100 includes an information transmitting unit 1103, a structure and function of which being according to Embodiment 4.

Furthermore, it includes main control circuit 1101, a memory 1102, a transceiver 1104 and an antenna 1105; wherein the memory 1102 may store a program for information transmission, and execute the program under the control of the main control circuit 1101, a process of executing the program being according to Embodiment 1, which shall not be described herein any further. Furthermore, the information transmitting unit 1103 may be combined with the main control circuit 1101 for use, and the memory 1102 may store a relationship between (E)PDCCH candidates.

### Embodiment 7

Embodiment 7 of the present disclosure provides a UE, including the information detecting apparatus as described in Embodiment 5, a particular structure of which being according to Embodiment 5, which shall not be described herein any further.

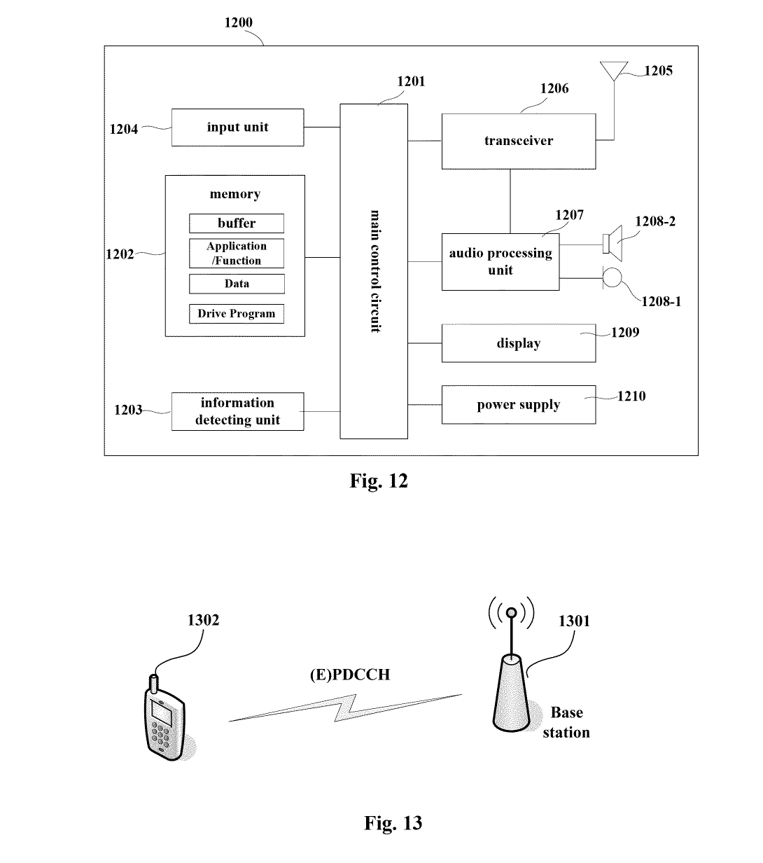

FIG. 12 is a schematic diagram of a structure of the UE according to Embodiment 7 of the present disclosure. As shown in FIG. 12, the UE 1200 includes an information detecting apparatus 1203, a particular structure of which being according to Embodiment 5, which shall not be described herein any further.

For example, the UE may be a mobile phone, and the figure is illustrative only. The mobile phone 1200 may further include other types of circuit components, so as to supplement or replace the operating circuit and achieve telecommunications function or other functions. It is obvious that the mobile phone 1200 may not necessarily include all the components shown in FIG. 12.

As shown in FIG. 12, the mobile phone 1200 includes main control circuit 1201, a transceiver 1206, an input unit 1204, an audio processing unit 1207, a memory 1202, a display 1209 and a power supply 1210. The main control circuit 1201 is sometimes referred to as a controller or a control, which may include a microprocessor or other processing devices and/or logic devices, and main control circuit 1201 receives input and controls operations of the components of the mobile phone 1200.

The memory 1202 may be, for example, one or more of a buffer, a flash memory, a hard drive, a mobile medium, a volatile memory, a nonvolatile memory, or other suitable devices, which may store the above program executing information detection. The main control circuit 1201 may execute the program stored by the memory 1202, so as to achieve information detection. And functions of other components are similar to the prior art, and shall not be described herein any further.

The components of the mobile phone 1200 may be realized by hardware, firmware, software, or a combination thereof, without departing from the scope of the present disclosure.

### Embodiment 8

FIG. 13 is a schematic diagram of a structure of the communication system according to Embodiment 8 of the present disclosure. As shown in FIG. 13, the communication system includes a base station and a UE; the base station may be the base station according to Embodiment 6, and the UE may be the UE according to Embodiment 7; and a method of transmitting information by the base station may be according to embodiments 1 and 2, and a process of detecting information by the UE may be according to Embodiment 3, which shall not be described herein any further.

It can be seen from the above embodiment that the (E)PDCCHs are transmitted by using the determined candidate paths, and the number of times of blind detection by the UE may be reduced.

The advantage of the embodiments of the present disclosure shall be described below with reference to particular examples.

Example 1: regarding the first case, for example, the aggregation level AL=8, the number of the candidates is M^{(L)}=2, and N=3 (the number of the subframes).

If an existing base station is used, in performing blind detection, the UE needs to exhaustively search (M^{(L)})^{N}=2³=8 times to find out the paths of N times of repeated transmission of the correct (E)PDCCHs over 3 subframes at an aggregation level 8, and the search space of each (E)PDCCH candidate over each subframe, i.e. the occupied CCEs, may be determined according to an existing standard.

If the above method according to the embodiment of the present disclosure is employed, at the base station side:

the relationship between the candidate numbers of the (E)PDCCHs carrying the control information may be configured by using high layer signaling (the candidate paths may be configured), such as configuring according to FIG. 5, the UE is notified of the configured candidate paths, and the (E)PDCCHs are transmitted according to the configured above candidate paths.

At the UE side:

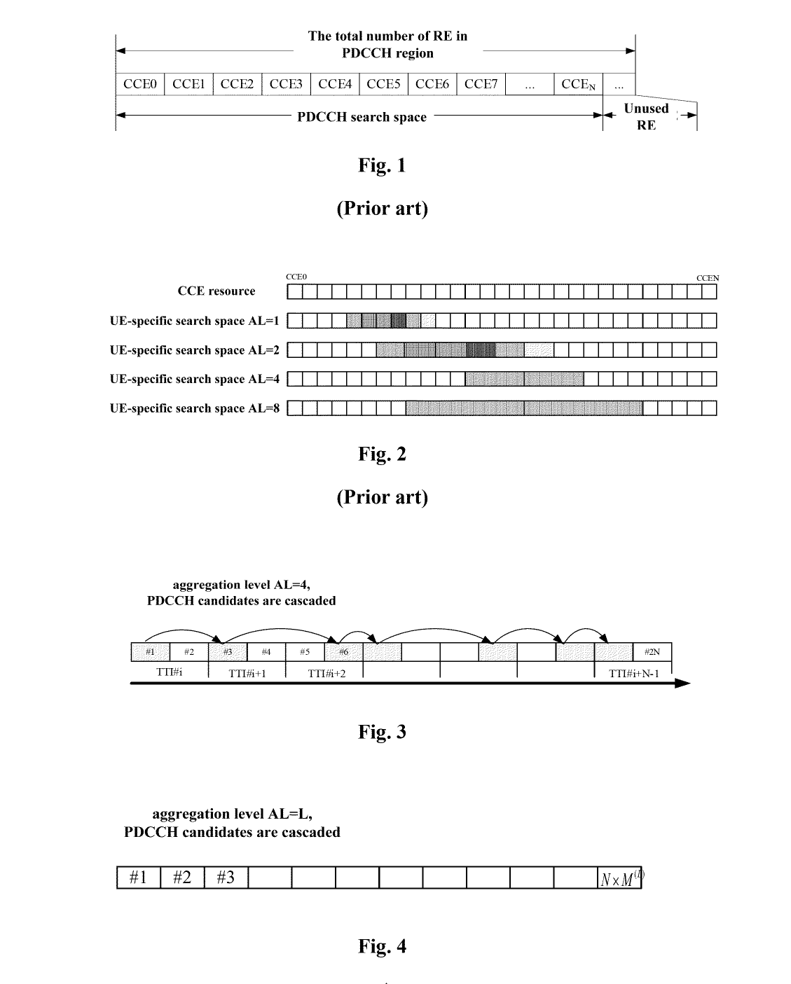

the UE determines the UE-specific search space, and as there exist corresponding (M^{(L)})^{N}=8 possible paths, but the UE-specific search space is a subset of the 8 possible paths, that is, it is less than 8, as shown in FIG. 5, there are 2 possible paths. If the detection is performed according to the paths shown in FIG. 1, the detection needs only to be performed M^{(L)}=2 times, and needs not to be performed 8 times. It can be seen therefrom that the number of times of blind detection is greatly reduced.

The number of the candidate paths shown in FIG. 6 is also 2, and the detection also needs not be performed 8 times.

Example 2: regarding the second case, that is, the aggregation level AL=8, the number of the candidates is M^{(L)}=2, N=3 (the number of the subframes), and K=5 (the total number of times of repetition).

If an existing base station is used, in performing blind detection, the UE needs to exhaustively search C_{M}_{^{(L)}}_{N}^{K}=6 times to find out the paths of N times of repeated transmission of the correct (E)PDCCHs over 3 subframes at an aggregation level 8, and the search space of each (E)PDCCH candidate over each subframe, i.e. the occupied CCEs, may be determined according to an existing standard.

If the above method according to the embodiment of the present disclosure is employed, at the base station side:

the relationship between the candidate numbers of the (E)PDCCHs carrying the control information, i.e. the candidate paths, may be configured via high layer signaling, such as configuring according to FIG. 5, the UE is notified of the configured candidate paths, and one of the candidate paths is selected to transmit the (E)PDCCHs.

At the UE side:

the UE determines the UE-specific search space according to the above predefined relationship, and as there exist corresponding C_{M}_{^{(L)}}_{N}^{K}=6 possible paths, but the UE-specific search space is a subset of the 6 possible paths, that is, it is less than 6.

In the above embodiment, the network side may indicate the above paths by using a bitmap. Furthermore, the paths may also be calculated by using a predefined relation, or the above paths may be indicated by some bits.

It can be seen from the above embodiment that when the UE blindly detects N pieces of DCI, the blind detection may be performed at most M^{(L)} times at a certain aggregation level AL, while the detection needs to be performed (M^{(L)})^{N} times in an existing mechanism. It can be seen that the embodiment of the present disclosure may greatly reduce the number of times of blind detection.

As to the above second case, similar to the first case, the relationship between the candidate numbers of the PDCCHs carrying the control information, i.e. the candidate paths, is predetermined, and when the UE blindly detects N pieces of DCI, the blind detection is performed at most f_{(N)}^{(L)} times at a certain aggregation level AL, while C_{M}_{^{(L)}}_{N}^{K} times of detection needs to be performed according to an existing mechanism, f_{(N)}^{(L)} being less than C_{M}_{^{(L)}}_{N}^{K}. It can be seen that the number of times of the blind detection may be greatly reduced with the embodiment of the present disclosure.

It can be seen from the above embodiment that the network side (such as a base station) selects one of the candidate paths, and selects corresponding (E)PDCCHs at different TTIs according to the relationship between the (E)PDCCH(E) candidate numbers in the candidate path to carry the transmission of the control information. The relationship between the candidate numbers of the (E)PDCCHs carrying the control information (such as DCI signaling) may be a determined relationship. Hence, when the (E)PDCCHs are repeatedly transmitted, the network side may transmit the (E)PDCCHs carrying the control information according to the relationship. The control signaling may be DCI.

At the UE side, a new UE-specific search space is defined, which refers to the combined candidate paths carrying the (E)PDCCH candidates over different subframes, the candidate paths being subsets of a set of all the paths. As described above, the number of the candidate paths needing to be monitored by each UE is defined. The relationship between the (E)PDCCH candidate numbers in each path may be a determined relationship, such as a relationship of which the UE is notified by the network side, or a relationship agreed on between both parties, or (E)PDCCH candidate numbers in the path at different TTIs are calculated according to a function expression, and then CCE resources occupied by each candidate number of (E)PDCCHs are calculated according to an existing standard. Hence, the UE may perform detection according to the UE-specific search space, thereby reducing the number of times of blind detection.

### Embodiment 9

Embodiment 9 of the present disclosure further provides an information configuring method, including: configures a mapping relationship between an aggregation level and the number of candidate paths; wherein the candidate paths are constituted by PDCCH or EPDCCH candidates carrying control information over different subframes.

The mapping relationship may be denoted by a table, such as the relationship shown in Table 2 or Table 3.

In this embodiment, the number of the configured candidate paths is less than or equal to the number of all paths constituted by the PDCCH or EPDCCH candidates.

### Embodiment 10

Embodiment 10 of the present disclosure further provides an information configuring apparatus, including: an information configuring unit configured to configure a mapping relationship between an aggregation level and the number of candidate paths; wherein the candidate paths are constituted by PDCCH or EPDCCH candidates carrying control information over different subframes. A particular configured mapping relationship is as shown in Table 2 or Table 3, which shall not be described herein any further.

### Embodiment 11

Embodiment 11 of the present disclosure further provides a base station, including the apparatus according to Embodiment 10.

### Embodiment 12

Embodiment 12 of the present disclosure further provides a communication system, including the base station according to Embodiment 11.

An embodiment of the present disclosure further provides a computer-readable program, wherein when the program is executed in an information transmitting apparatus or a base station, the program enables a computer to carry out the information transmitting method according to embodiments 1 and 2 in the information transmitting apparatus or the base station.

An embodiment of the present disclosure further provides a storage medium in which a computer-readable program is stored, wherein the computer-readable program enables a computer to carry out the information transmitting method according to embodiments 1 and 2 in an information transmitting apparatus or a base station.

An embodiment of the present disclosure further provides a computer-readable program, wherein when the program is executed in an information detecting apparatus or a user equipment, the program enables a computer to carry out the information detecting method according to Embodiment 3 in the information detecting apparatus or the user equipment. An embodiment of the present disclosure further provides a storage medium in which a computer-readable program is stored, wherein the computer-readable program enables a computer to carry out the information detecting method according to Embodiment 3 in an information detecting apparatus or a user equipment.

An embodiment of the present disclosure further provides a computer-readable program, wherein when the program is executed in an information configuring apparatus or a base station, the program enables a computer to carry out the information configuring method according to Embodiment 9 in the information configuring apparatus or the base station.

An embodiment of the present disclosure further provides a storage medium in which a computer-readable program is stored, wherein the computer-readable program enables a computer to carry out the information configuring method according to Embodiment 9 in an information configuring apparatus or a base station.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principles of the present disclosure, and such variants and modifications fall within the scope of the present disclosure.

What is claimed is:

1. An information transmitting apparatus, comprising:
an information transmitting unit configured to repeatedly transmit control information over multiple subframes; wherein a physical downlink control channel (PDCCH) or an enhanced physical downlink control channel (EPDCCH) is transmitted by using one of candidate paths constituted by PDCCH or EPDCCH candidates carrying the control information over different subframes.

2. The apparatus according to claim 1, wherein the number of the candidate paths is less than or equal to the number of all paths constituted by the PDCCH or EPDCCH candidates.

3. The apparatus according to claim 1, wherein the apparatus further comprising:
a first path determining unit configured to configure the candidate paths by using high layer signaling, or calculate the candidate paths according to a predefined relation, or determine the candidate paths according to prestored path information.

4. The apparatus according to claim 1, wherein the apparatus further comprising:
a first path number determining unit configured to preconfigure the number of the candidate paths, or determine the number of the candidate paths according to prestored path number information.

5. The apparatus according to claim 1, wherein, when the PDCCH or EPDCCH is transmitted over N subframes and is transmitted once over each of the N subframes, the number of all paths constituted by the PDCCH or EPDCCH candidates carrying the control information over different subframes is (M^{(L)})^{N};
and when the PDCCH or EPDCCH is transmitted over the N subframes and is transmitted for K times over each of the N subframes, the number of all paths constituted by the PDCCH or EPDCCH candidates carrying the control information over different subframes is C_{M}_{^{(L)}}_{N}^{K}; where, N and K are both positive integers.

6. The apparatus according to claim 3, wherein when the candidate paths are calculated according to a relation, the relation is related to a radio network identifier of a user equipment, a starting frame number of the current repetition of the PDCCH or EPDCCH, an i-th transmission time internal (TTI) of the current repetition of the PDCCH or EPDCCH, and a candidate path number #a; where, i=0, 1, 2, . . . , N−1, and a=1, 2, . . . , A^{(L)}.

7. An information detecting apparatus, comprising:
a search space determining unit configured to determine candidate paths for physical downlink control channels (PDCCHs) or enhanced physical downlink control channels (EPDCCHs) carrying control information; wherein the candidate paths are constituted by PDCCH or EPDCCH candidates carrying the control information over different subframes; and
a detecting unit configured to perform detection according to paths to which the candidate paths correspond.

8. The apparatus according to claim 7, wherein the apparatus further comprising:
a second path determining unit configured to receive candidate paths of PDCCH or EPDCCH carrying control information configured by a network side, or calculate the candidate paths according to a predefined relation, or determine the candidate paths according to prestored path information.

9. The apparatus according to claim 7, wherein the number of the candidate paths is less than or equal to the number of all paths constituted by the PDCCH or EPDCCH candidates.

10. The apparatus according to claim 9, wherein the apparatus further comprising:
a second path number determining unit configured to receive the number of the candidate paths preconfigured by a network side, or determine the number of the candidate paths according to prestored path number information.

11. The apparatus according to claim 7, wherein, when the PDCCH or EPDCCH is transmitted over N subframes and is transmitted once over each of the N subframes, the number of all paths constituted by the PDCCH or EPDCCH candidates carrying the control information over different subframes is (M^{(L)})^{N};
and when the PDCCH or EPDCCH is transmitted over the N subframes and is transmitted for K times over each of the N subframes, the number of all paths constituted by the PDCCH or EPDCCH candidates carrying the control information over different subframes is C_{M}_{^{(L)}}_{N}^{K}; where, N and K are both positive integers.

12. The apparatus according to claim 8, wherein when the candidate paths are calculated according to a relation, the relation is related to a radio network identifier of a user equipment, a starting frame number of the current repetition of the PDCCH or EPDCCH, an i-th transmission time internal (TTI) of the current repetition of the PDCCH or EPDCCH, and a candidate path number #a; where, i=0, 1, 2, . . . , N−1, and a=1, 2, . . . , A^{(L)}.

13. A communication system, comprising:
a base station comprising an information transmitting apparatus, that comprises an information transmitting unit configured to repeatedly transmit control information over multiple subframes; wherein a physical downlink control channel (PDCCH) or an enhanced physical downlink control channel (EPDCCH) is transmitted by using one of candidate paths constituted by PDCCH or EPDCCH candidates carrying the control information over different subframes; and
a user equipment comprising an information transmitting apparatus that comprises a search space determining unit configured to determine candidate paths for physical downlink control channels (PDCCHs) or enhanced physical downlink control channels (EPDCCHs) carrying control information; wherein the candidate paths are constituted by PDCCH or EPDCCH candidates carrying the control information over different subframes; and
a detecting unit configured to perform detection according to paths to which the candidate paths correspond.

14. An information configuring apparatus, comprising:
an information configuring unit configured to configure a mapping relationship between an aggregation level and the number of candidate paths; wherein the candidate paths are constituted by physical downlink control channel (PDCCH) or enhanced physical downlink control channel (EPDCCH) candidates carrying control information over different subframes.

15. The apparatus according to claim 14, wherein the number of the candidate paths is less than or equal to the number of all paths constituted by the PDCCH or EPDCCH candidates.
